(19) United States
(12) Patent Application Publication
(10) Pub. No.: US 2001/0049562 A1
(43) Pub. Date: Dec. 6, 2001

(54) Control system and control method

(76) Inventors: Takuo Takano, Fujisawa-shi (JP); Masaru Takada, Yokohama-shi (JP)

Correspondence Address: PILLSBURY WINTHROP LLP, 1600 TYSONS BOULEVARD, MCLEAN, VA, 22102, US

(21) Appl. No.: 09/801,790

(22) Filed: Mar. 9, 2001

(30) Foreign Application Priority Data
Mar. 10, 2000 (JP) 2000-066852
Jun. 8, 2000 (JP) 2000-172461

(51) Int. Cl. G05B 11/01

(52) U.S. Cl. 700/19; 700/9

(57) ABSTRACT

This invention responds easily to a plurality of different situations and simplifies control. A desired sequence of operations can be executed by using job commands to elicit the functions of control modules, and by using state commands to cause these control modules to undergo state transitions. Furthermore, when a situation occurs that makes it desirable for control modules to undergo state transitions as a matter of urgency during the execution of a sequence, this can be achieved by means of an event command.

### CROSS REFERENCE TO RELATED APPLICATIONS

The present invention claims priority from Japanese Patent Applications No. 2000-066852 filed Mar. 10, 2000 and No. 2000-172461 filed Jun. 8, 2000, the contents of which are incorporated herein by reference.

### BACKGROUND OF THE INVENTION

1. Field of the Invention

The present invention relates to a technique for standardizing computer programs used for control purposes. It relates in particular to a technique for standardizing the design, modification and major alteration of such programs, and for running them more simply. The invention also relates to a control system wherein a plurality of control modules are arranged in an hierarchical structure and serve to individually control a plurality of controlled elements contained within a single controlled system. The invention further relates to a control program for this control system.

2. Description of Related Art

A previously proposed structure of a control system comprises providing a plurality of controlled elements in a single control system, providing a plurality of control modules for individually controlling these controlled elements, and controlling these control modules hierarchically.

Regarding such a control system, the present applicant has proposed a technique wherein all the control modules have a standardized set of modes and mode transitions, and the components of the overall control system are in an hierarchical structure, which is disclosed in JP H11-305806 A and JP H11-338517 A, hereinafter referred as “prior applications”. Each control module in the present application is understood to be such a component.

The prior applications propose a technique whereby constructing, updating and modifying an hierarchically structured control system is easily achieved on the basis of standardizing the modes and mode transitions of the control modules. However, although the prior applications use a command to bring about mode transitions, there is only one type of command. In other words, no particularly detailed study had been made of commands.

In the present application, the applicant has focused on the fact that the control system of the prior applications can be made even easier to use by employing a plurality of command types with different characteristics.

This can be achieved by for example providing a convenient command for dealing with circumstances that differ from normal operation, as when the control system is initialized or when a fault occurs. Alternatively, restrictions on controlled elements or the order in which these elements are controlled can easily be set by providing commands with different scopes.

The present invention has been devised against this technical background. It is an object of the invention to provide a control system and control method capable of responding easily to a plurality of different situations, and of simplifying control, by using a plurality of command types with different characteristics.

### SUMMARY OF THE INVENTION

In a first aspect, the invention is a control system comprising a plurality of control modules for individually controlling a plurality of controlled elements, this plurality of control modules being configured in a tree-like hierarchical structure, and all the control modules being provided with a common set of modes and mode transitions.

A distinguishing feature of the invention according to this first aspect is that the commands that can be given to each control module comprise: a first command that is validly received on the basis of preemption processing whereby the command issuing source acquires in advance the right to issue the command to a control module that constitutes the destination of that command, and that is valid at that control module only; a second command that is validly received on the basis of the aforementioned preemption processing, but that is also valid at a subordinate control module provided that this has not been preempted by a command issuing source other than the command issuing source of the second command; and a third command that does not require the aforementioned preemption processing in order to be received, and that is also valid at a control module that is subordinate to the control module in question.

Preferably, the first command is a “job command” for ordering a “job” that executes a function of the control module in question; the second command is a “state command” for ordering a state transition of the control module in question; and the third command is an “event command” for causing a mode transition of the control module in question and of all its subordinate control modules.

Preferably, when a control module has received a second command and a subordinate control module has been preempted by a command issuing source other than the command issuing source of said second command, the state transition of that preempted control module is inhibited until its preemption processing is cancelled.

In other words, a desired sequence of operations can be executed by using job commands to elicit the functions of control modules, and by using state commands to cause these control modules to undergo state transitions. In addition, when a situation occurs that makes it desirable for control modules to undergo state transitions as a matter of urgency during the execution of a sequence, this can be achieved by means of an event command.

Job and state commands are therefore commands that require the aforementioned preemption processing to be carried out in advance relative to the control module that constitutes the destination of the command, and they are commands that become valid for this preempted control module. As opposed to this, an event command does not require preemption processing to be carried out in advance, and can be issued to any desired control module.

Preferably, the aforementioned modes and mode transitions comprise: a start mode for controlling the starting of the corresponding controlled elements; a normal operating mode to which direct transition can be made from the start mode, and which controls the normal operation of said controlled elements; a stop mode to and from which mutual direct transitions can be made from and to the normal operating mode, said stop mode controlling the stopping of said controlled elements; a hold mode to and from which mutual direct transitions can be made from and to the stop mode, and from which direct transition can be made to the start mode, said hold mode controlling the aforementioned controlled elements in a hold state; a reverse mode to which direct transition can be made from the hold mode, and to and from which mutual direct transitions can be made from and to the stop mode, said reverse mode controlling the reversing of the aforementioned controlled elements; a manual control mode to which direct transition can be made from the hold mode, and to and from which mutual direct transitions can be made from and to the stop mode, and from which transitions can be made to the normal operating mode or the start mode, said manual control mode being used for manual control of the aforementioned controlled elements; an alarm mode to which transition can be made from any of the aforementioned modes and which generates an alarm; an exceptional operating mode to which transition can be made from any of the aforementioned modes and which temporarily causes at least some of these modes to operate out-of-step; and an end mode to which direct transition can be made from the hold mode, and which terminates the control of the controlled elements.

The start mode preferably comprises a cold start mode which creates a control file, and a hot start mode to which a transition is made from this cold start mode, and which writes the file data to RAM.

The normal operating mode preferably comprises an origin mode for confirming that the controlled elements are at their origins; a restoration mode for restoring a sequence of automatically operating controlled elements to the state just before the sequence was interrupted; a preparation mode which prepares for automatic operation of the controlled elements; and a running mode for automatically operating the controlled elements.

The stop mode preferably comprises an urgent stop mode for urgently stopping the operation of the controlled elements; a decelerating stop mode for gradually stopping the operation of the controlled elements; and a stepped stop mode for stopping the operation of the controlled elements at breaks in the sequence.

The hold mode preferably comprises a CPU stop mode capable of stopping the CPU; a control release mode for releasing the controlled elements from control; a control restore mode for bringing the released controlled elements back under control; and a diagnostic mode capable of converting the operating state of the controlled elements into data and of modifying the control specification.

The alarm mode preferably comprises an abnormality stop mode for stopping the operation of a controlled element when an abnormality has been detected in its operation; and an emergency stop mode for making an emergency stop in accordance with external instructions, irrespective of the operating status.

In a second aspect, the present invention is a control method for a control system comprising a plurality of control modules for individually controlling a plurality of controlled elements, the plurality of control modules being configured in an hierarchical structure, and all control modules being provided with a common set of modes and mode transitions.

A distinguishing feature of the invention according to this second aspect is that the job command for eliciting a function of a control module is issued after the job command issuing source has performed preemption processing for acquiring in advance the right to issue the job command to a control module that constitutes the destination of that job command; the state command for causing a transition of the state of a control module is issued by the state command issuing source after it has performed preemption processing for acquiring in advance the right to issue a state command to a control module that constitutes the destination of that state command; said state command causing a transition of the state of that control module and of a subordinate control module provided that this has not been preempted by a state command issuing source other than the state command issuing source in question; and when it is necessary to make the hierarchy of control modules undergo a transition all together as a matter of urgency, an event command that is valid at all the control modules is issued without performing the aforementioned preemption processing.

It may be noted that although preemption processing is not required in order to issue an event command, a control module that receives an event command performs, either simultaneously with or subsequent to receipt of the event command, the same processing as when it is preempted by another control module. If this processing is cancelled, the control module can undergo appropriate state transition in accordance with the state of an hierarchically superior control module.

Moreover, a control module that is connected hierarchically below a control module that has received an event command should have an existing state of preemption cancelled when it receives the event command.

Examples of a control module that has received an event command and that performs “the same processing as when it is preempted by another control module” would be recording information relating to the issuing source of that event command, and deleting this recorded information when the event command is cancelled. Such processing facilitates recognition of the validity or invalidity of the processing by the event command issuing source.

### BRIEF DESCRIPTION OF THE DRAWINGS

Specific embodiments of the present invention will now be described, by way of example only, with reference to the accompanying of drawings in which:

FIG. 1 shows the configuration of a control system according to the prior applications,

FIG. 2 is a block diagram of a control module according to the prior applications,

FIG. 3 shows the operation of the job command,

FIG. 4 shows the operation of the state command,

FIG. 5 shows the operation of the event command,

FIG. 6 shows the operation of preemption,

FIG. 7 shows the operation of canceling preemption,

FIG. 8 shows competition for preemption,

FIG. 9 shows self preemption,

FIG. 10 shows the configuration of a lathe, and

FIG. 11 shows a control system diagram of a lathe.

### DETAILED DESCRIPTION OF THE PREFERRED EMBODIMENTS

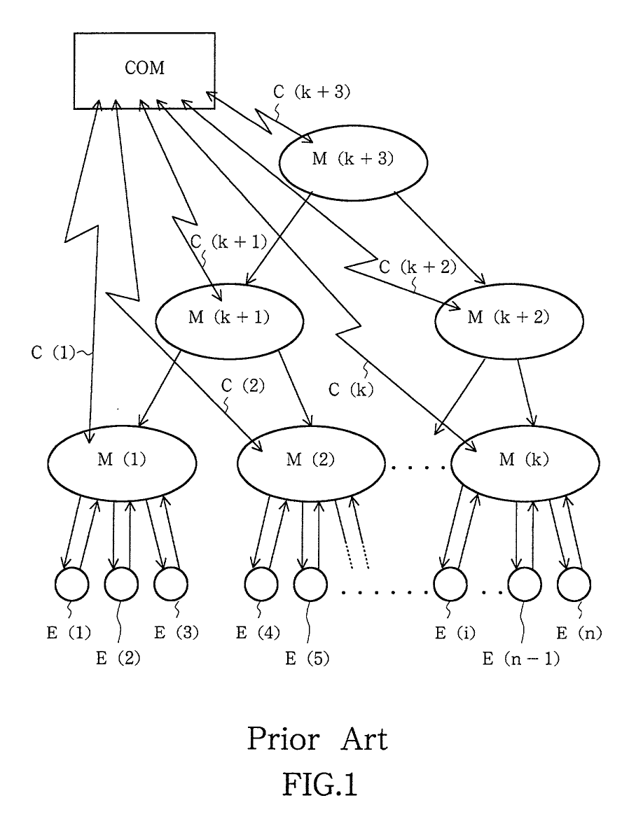

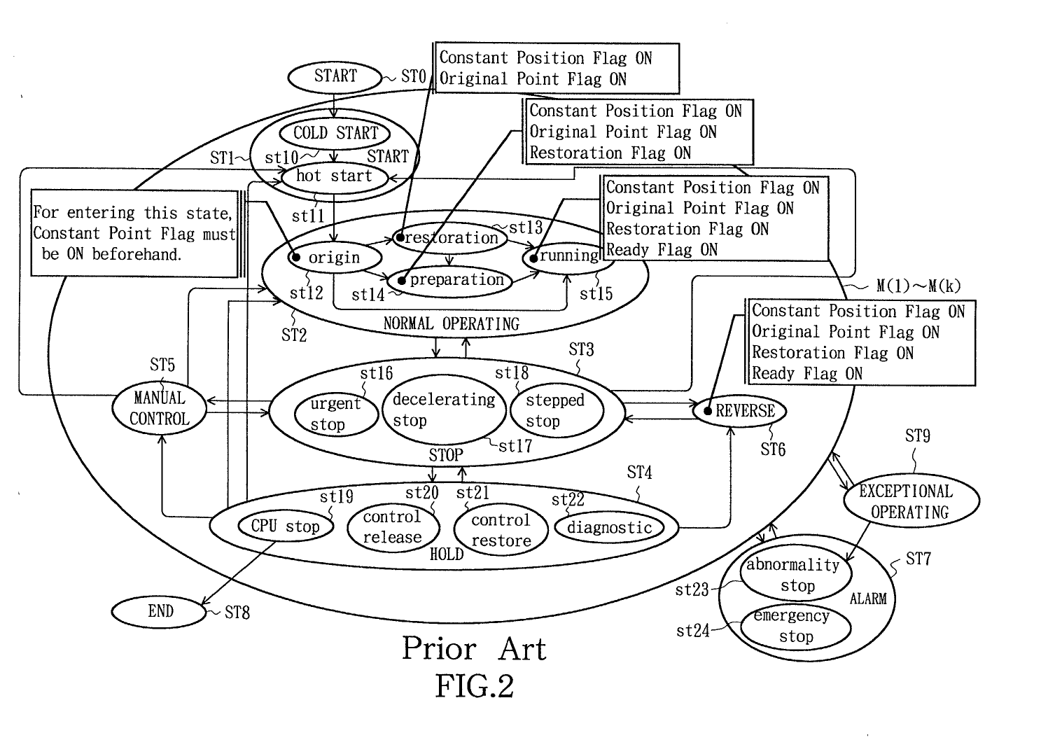

For understanding this invention, the above-mentioned prior applications will be described with reference to FIG. 1 and FIG. 2. FIG. 1 shows the configuration of the control system according to the prior applications, while FIG. 2 is a block diagram of a control module according to these applications. As shown in FIG. 1, the previously proposed control system structure comprises providing a plurality of controlled elements E(1) to E(n); providing a plurality of control modules M(1) to M(k+3) for individually controlling these controlled elements E(1) to E(n); and controlling these control modules M(1) to M(k+3) hierarchically. Communication between control modules M(1) to M(k+3) is carried out by way of communication lines C(1) to C(k+3) and communication memory COM.

In this control system, even if a certain control module does not use one of the modes belonging to the basic module, that mode is still provided in conformity with the basic module. Moreover, the modes and mode transitions are not extended beyond those provided in the basic module. If there is a need to extend the modes and mode transitions available, another basic module is designed. All the control module modes and mode transitions are standardized in at least one closed control system. All sorts of control states can be designed by setting parameters for these modes and mode transitions in accordance with the conditions imposed by the control specification and the controlled elements.

In other words, the control system is constructed from control modules that have identical modes and mode transitions, but the functioning of each control module is based on activation of only those modes and mode transitions that are necessary for the module in question to perform the control required of it.

As shown in FIG. 2, the modes and mode transitions of a control module comprise: start mode ST1 for controlling the starting of the corresponding controlled elements; normal operating mode ST2 to which direct transition can be made from start mode ST1, and which controls the normal operation of said controlled elements; stop mode ST3 to and from which mutual direct transitions can be made from and to normal operating mode ST2, said stop mode ST3 controlling the stopping of said controlled elements; hold mode ST4 to and from which mutual direct transitions can be made from and to stop mode ST3, and from which direct transition can be made to start mode ST1, said hold mode ST4 controlling the aforementioned controlled elements in a hold state; reverse mode ST6 to which direct transition can be made from hold mode ST4, and to and from which mutual direct transitions can be made from and to stop mode ST3, said reverse mode ST6 controlling the reversing of the aforementioned controlled elements; manual control mode ST5 to which direct transition can be made from hold mode ST4, and to and from which mutual direct transitions can be made from and to stop mode ST3, and from which transitions can be made to normal operating mode ST2 or start mode ST1, said manual control mode ST5 being used for manual control of the aforementioned controlled elements; alarm mode ST7 to which transition can be made from any of the above-mentioned modes and which generates an alarm; exceptional operating mode ST9 to which transition can be made from any of modes ST1 to ST6 and which temporarily causes at least some of modes ST1 to ST6 to operate out-of-step; and end mode ST8 to which direct transition can be made from hold mode ST4, and which terminates the control of the controlled elements.

Thus, by standardizing the modes and mode transitions that the control modules have in common, a control module can be treated in terms of the concept of a component of the control system. Furthermore, by constructing the control system by assembling such components, the control system can be updated in terms of the concept of replacing components.

The configuration of a control system according to an embodiment of this invention will be described with reference to FIG. 1 and FIG. 2. These figures also apply to the embodiment of the present invention that will now be described.

This embodiment of the invention is a control system comprising a plurality of control modules M(1) to M(k+3) for individually controlling a plurality of controlled elements E(l) to E(n), this plurality of control modules M(1) to M(k+3) being configured in a tree-like hierarchical structure, and all the control modules M(1) to M(k+3) being provided with a common set of modes and mode transitions.

A distinguishing feature of this embodiment is that the commands that can be given to each control module M(1) to M(k+3) comprise: a job command that is validly received on the basis of preemption processing (hereinafter, termed simply “preemption”) whereby the command issuing source acquires in advance the right to issue the command to a control module M(i) (where i is any number from 1 to k+3 inclusive) that constitutes the destination of that command, and that is valid at that control module M(i) only; a state command that is validly received on the basis of preemption, but that is also valid at a control module M(j) (where j is any number from 1 to k+3 inclusive and is not equal to i) that is subordinate to control module M(i) and that has not been preempted by a command issuing source other than the command issuing source of the state command; and an event command that can be received without the need for preemption of control module M(i) that is the destination of the command, and that is also valid at a control module M(j) that is subordinate to control module M(i).

The job command is a command for ordering a job that executes a function of control module M(i); the state command is a command for ordering a state transition of control module M(i); and the event command is a command for causing a mode transition of control module M(i) and of all its subordinate control modules M(j).

However, when a control module M(i) has received a state command and a subordinate control module M(j) has been preempted by another state command issuing source, the state transition of this preempted control module M(j) is inhibited until its preemption is cancelled.

The aforementioned modes and mode transitions comprise: start mode ST1 for controlling the starting of the corresponding controlled elements; normal operating mode ST2 to which direct transition can be made from start mode ST1, and which controls the normal operation of said controlled elements; stop mode ST3 to and from which mutual direct transitions can be made from and to normal operating mode ST2, said stop mode ST3 controlling the stopping of said controlled elements; hold mode ST4 to and from which mutual direct transitions can be made from and to stop mode ST3, and from which direct transition can be made to start mode ST1, said hold mode ST4 controlling the aforementioned controlled elements in a hold state; reverse mode ST6 to which direct transition can be made from hold mode ST4, and to and from which mutual direct transitions can be made from and to stop mode ST3, said reverse mode ST6 controlling the reversing of the aforementioned controlled elements; manual control mode ST5 to which direct transition can be made from hold mode ST4, and to and from which mutual direct transitions can be made from and to stop mode ST3, and from which transitions can be made to normal operating mode ST2 or start mode ST1, said manual control mode ST5 being used for manual control of the aforementioned controlled elements; alarm mode ST7 to which transition can be made from any of the aforementioned modes and which generates an alarm; exceptional operating mode ST9 to which transition can be made from any of the aforementioned modes and which temporarily causes at least some of these modes to operate out-of-step; and end mode ST8 to which direct transition can be made from hold mode ST4, and which terminates the control of the controlled elements.

Start mode ST1 comprises cold start mode st10 which creates a control file, and hot start mode stll to which a transition is made from this cold start mode st10, and which writes the file data to RAM.

Normal operating mode ST2 comprises origin mode st12 for confirming that the controlled elements are at their origins; restoration mode st13 for restoring a sequence of automatically operating controlled elements to the state just before the sequence was interrupted; preparation mode st14 which prepares for automatic operation of the controlled elements; and running mode st15 for automatically operating the controlled elements.

Stop mode ST3 comprises urgent stop mode st16 for urgently stopping the operation of the controlled elements; decelerating stop mode st17 for gradually stopping the operation of the controlled elements; and stepped stop mode st18 for stopping the operation of the controlled elements at breaks in its sequence.

Hold mode ST4 comprises CPU stop mode st19 capable of stopping the CPU; control release mode st2O for releasing the controlled elements from control; control restore mode st21 for bringing the released controlled elements back under control; and diagnostic mode st22 capable of converting the operating state of the controlled elements into data and of modifying the control specification.

Alarm mode ST7 comprises abnormality stop mode st23 for stopping the operation of a controlled element when an abnormality has been detected in its operation; and emergency stop mode st24 for making an emergency stop in accordance with external instructions, irrespective of the operating status.

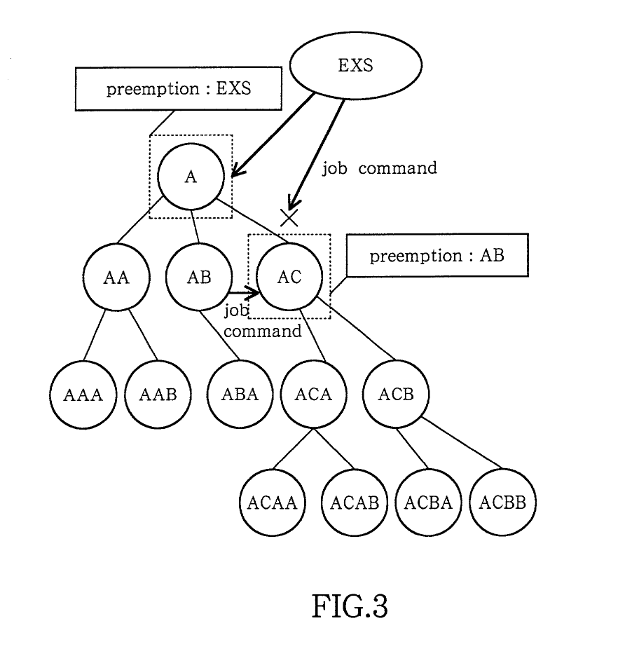

Next, the operation of each command used in a control system according to this embodiment of the invention will be described with reference to FIG. 3 to FIG. 9 inclusive. First of all, the job command will be described. A job command is used to elicit a function of a control module. A job command issuing source can cause the control module to which the command has been issued to manifest the function corresponding to that job command.

When a control module has received a job command, it can manifest the function corresponding to that job command if that function has been included within it.

In order to issue a job command, it is necessary to acquire in advance the right to issue the command to a destination control module, and as has previously been mentioned, in this embodiment the process of acquiring this right will be called “preemption”. It may be noted that preemption is also required in order to issue the state command that will be described below. Hence the scope for issuing and receiving job and state commands is restricted to control modules that perform and receive preemption.

In greater detail, a control module is provided with a flag which indicates validity when that control module has been preempted and, corresponding to this flag, with a table in which is recorded the control module or external system that is the preemption source. This table also indicates whether the preemption in question is for a job command or for a state command.

Next, the operation of the job command will be described with reference to FIG. 3. In FIG. 3, external system EXS has preempted control module A, and control module AB has preempted control module AC. Under these circumstances, only control module AB can issue a job command to control module AC, and a job command issued by control module AB is valid only at control module AC. In addition, only external system EXS can issue a job command to control module A, and a job command issued by external system EXS is valid only at control module A.

Next, the state command will be described. A state command is used to cause a transition in the state of a control module. The state command issuing source can cause the state of the control module to which the command has been issued to undergo a transition to a state corresponding to the state command. When the control module has received the state command, it can undergo transition to the state corresponding to that state command. A state command differs from a job command in that it also affects a control module that is subordinate in the tree structure to the control module whose state has undergone transition as a result of the state command. As in the case of a job command, it is necessary to preempt the destination control module when issuing a state command.

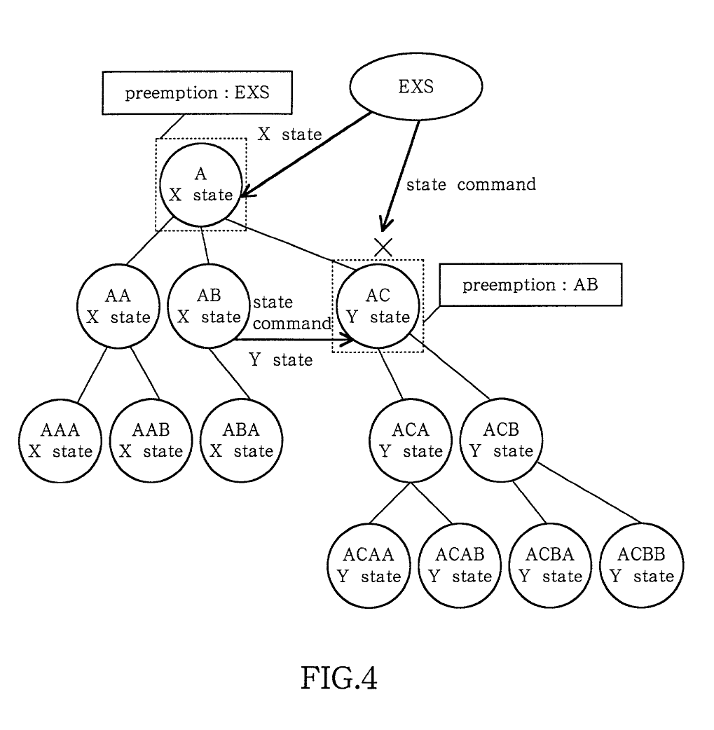

The operation of the state command will be described with reference to FIG. 4. In FIG. 4, external system EXS has preempted control module A, and control module AB has preempted control module AC. Only preempting control module AB can issue a state command to control module AC. A state command issued by control module AB extends not only to control module AC, but also to control modules ACA, ACB, ACAA, ACAB, ACBA and ACBB, which are subordinate to control module AC.

State commands to control module A can be issued only by preempting external system EXS. However, state commands issued by external system EXS extend to control modules AA, AB, AAA, AAB and ABA as well. Note however that because control module AC has been preempted, this control module AC and its subordinate control modules are not affected by state commands issued by external system EXS.

A control module at which preemption has been cancelled undergoes state transitions in accordance with state commands of control modules that are hierarchically above it in the tree structure, and control modules that are subordinate to this control module at which preemption has been cancelled also conform to these state transitions. For example, if the preemption of control module AC is cancelled, control module AC inherits state X of control module A that is superior to it in the tree structure, and control modules ACA, ACB, ACAA, ACAB, ACBA and ACBB all undergo transition to state X.

Next, the event command will be described. An event command is used to transfer extremely urgent information between control modules. An event command issuing source can instantly transfer its state to the control module to which the command has been issued, and can thereby implement processing corresponding to this event command. When a control module receives an event command, it can undergo transition to a processing state corresponding to that event command. An event command is valid at the control module that receives it and at control modules subordinate to this control module. Because an event command has a high degree of urgency, preemption is not required.

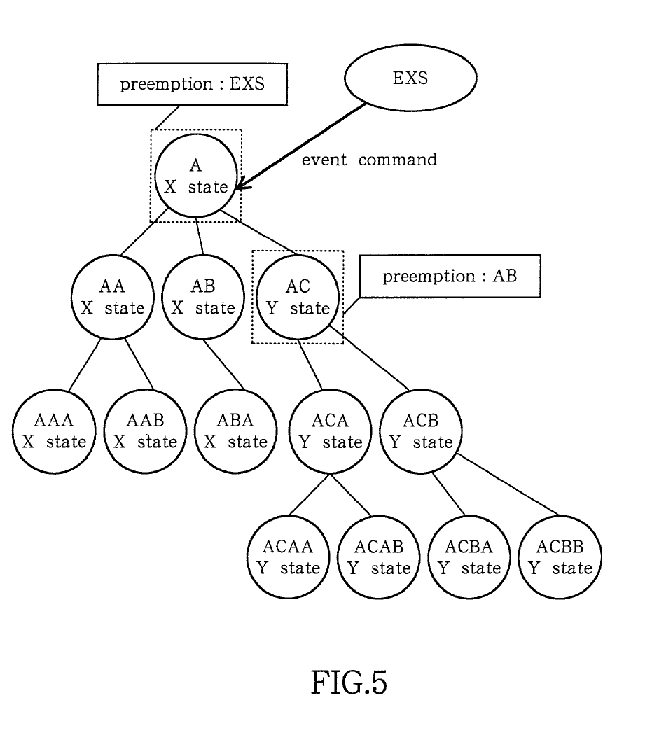

The operation of the event command will be described with reference to FIG. 5. In FIG. 5, external system EXS has preempted control module A, and control module AB has preempted control module AC. As noted above, any control module or external system EXS can issue an event command to a subordinate control module irrespective of whether that module has been preempted.

For example, in FIG. 5, when external system EXS has issued an event command to control module A, this event command is transferred to all other control modules AA, AB, AC, AAA, AAB, ABA, ACA, ACB, ACAA, ACAB, ACBA and ACBB.

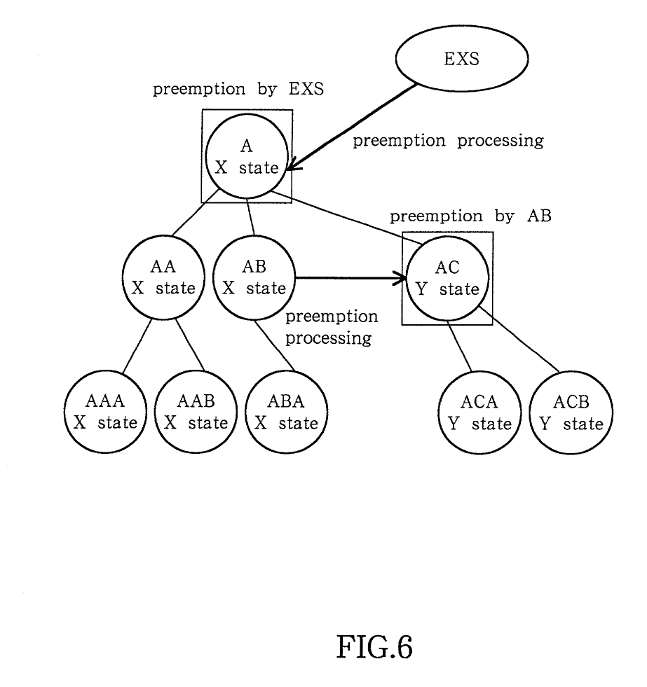

Next, preemption will be described in greater detail with reference to FIG. 6 to FIG. 9. The object of preemption is to acquire the right to issue job and state commands to a control module that is to be operated, and, until the preemption is cancelled, to block job and state commands from control modules or external systems that have not acquired this right.

This makes it possible to avoid collision between commands that have been issued from a plurality of control modules. It also makes it possible to guarantee the availability of a control module that is shared among different control modules. In addition, it makes it possible to guarantee that even if a control module is in a position in the hierarchical tree structure that exposes it to the effect of a command, until preemption is cancelled that control module will not be affected by such a command and can maintain its specific state.

Preemption processing can originate from a control module within the system or from external system EXS, and a control module can preempt itself. Preemption is not subject to any restrictions regarding time, state or tree structure. However, a control module that is already being preempted cannot be subject to another preemption, and so any further preemption will be rejected. Like preemption, cancellation of preemption is not subject to any restrictions regarding time, state or tree structure, and hence preemption can always be cancelled. However, only the source of a preemption can cancel that preemption. Until its preemption is cancelled, a preempted control module maintains its state and cannot be subject to a joint preemption from another control module. Like preemption and cancellation of preemption, receiving preemption is not subject to any restrictions regarding time, state or tree structure.

Next, the operation of preemption will be described with reference to FIG. 6. The initial situation in FIG. 6 is that all the control modules A, AA, AB, AC, AAA, AAB, ABA, ACA and ACB are in some particular state and none of the control modules has been preempted. Control module AB then preempts control module AC by means of the preemption processing between control modules AB and AC labeled (1) in FIG. 6. Once control module AC has become preempted by control module AB, it undergoes transition to a specific state (in FIG. 6, shown as state Y) as a result of a state command being issued from control module AB to control module AC.

This new state of control module AC propagates down the hierarchical tree structure to subordinate control modules ACA and ACB, at which the propagation ends. At this point in time, the preemption of control module AC has not been cancelled. After this, external system EXS preempts control module A by means of the preemption processing between external system EXS and control module A labeled (2) in FIG. 6. Once control module A has become preempted by external system EXS, it undergoes transition to a specific state (in FIG. 6, shown as state X) as a result of a state command being issued from external system EXS to control module A.

This new state of control module A propagates down the hierarchical tree structure to subordinate control modules AA, AAA, AAB, AB and ABA, at which the propagation ends. Because at this point in time the node comprising control module AC is still preempted by control module AB, the state of control module A does not propagate to control module AC.

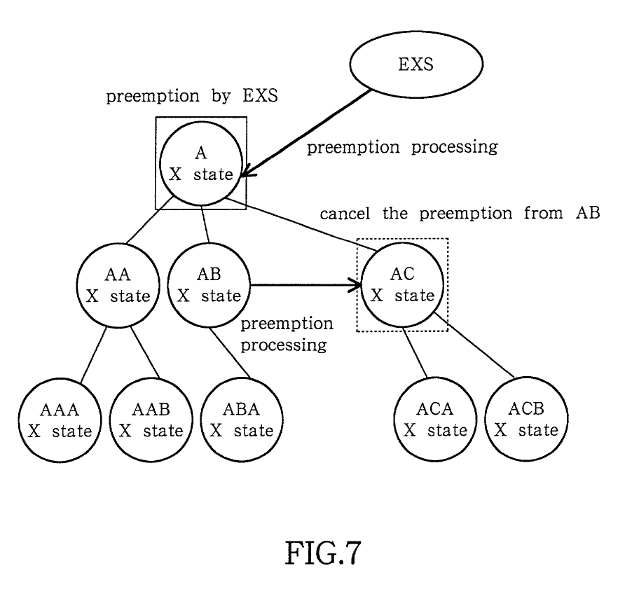

FIG. 7, where the situation illustrated in FIG. 6 is taken as the initial condition, further illustrates the nature of propagation down the hierarchical tree structure of the state corresponding to the state command. Namely, immediately after the preemption of control module AC has been cancelled by control module AB, the state of control module A is automatically propagated to control module AC that is subordinate to control module A, and then to control modules ACA and ACB that are subordinate to control module AC, whereupon the propagation of the state of control module A is completed.

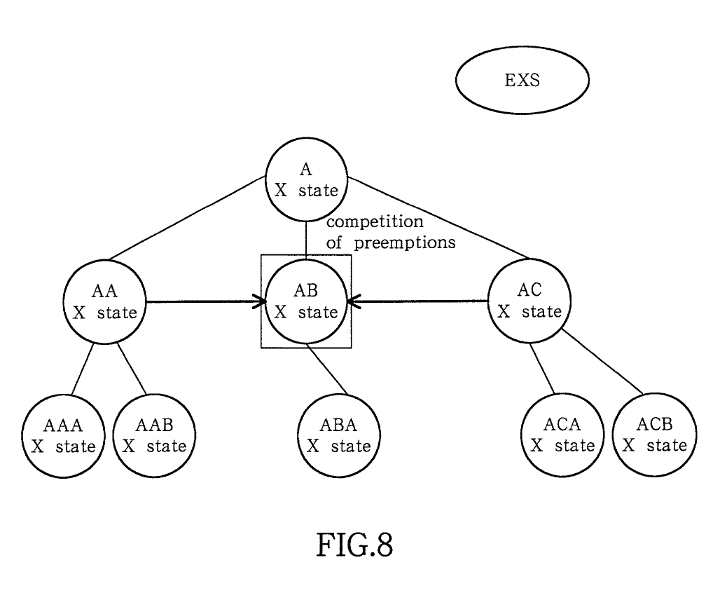

In FIG. 8, control modules AA, AB and AC are subordinate to control module A in the hierarchical tree structure. If the control configuration is such that control module AB is a component used by both control modules AA and AC, then these control modules have to compete to acquire the right, by means of preemption, to use control module AB. In such a case, because control modules AA and AC cannot preempt control module AB simultaneously, the one that preempts first acquires the right to use control module AB.

If control module AA has succeeded in preempting control module AB, control module AC cannot preempt control module AB until its preemption has been cancelled. However, this does not guarantee preemption of control module AB by control module AC, and it is possible that preemption will be achieved by control module AA again or by another system.

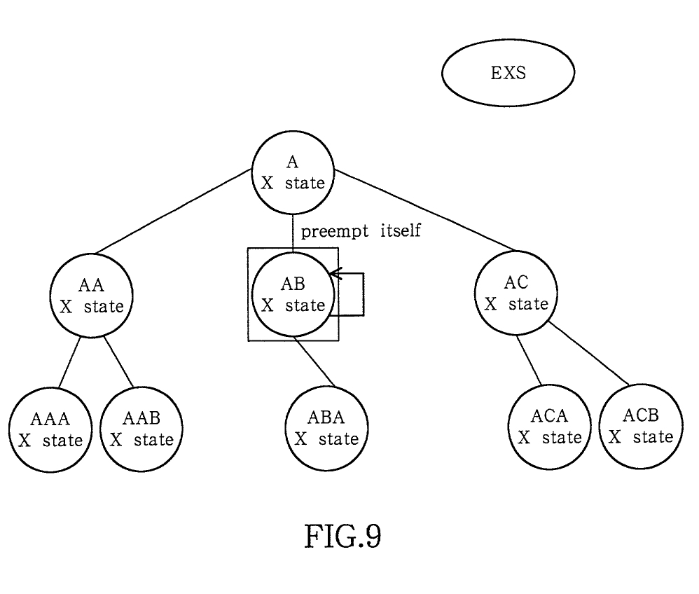

As illustrated in FIG. 9, it is also possible for control module AB to preempt itself in order to preserve its own state and processing.

It may be noted that although preemption processing is not required in order to issue an event command, a control module that receives an event command performs, either simultaneously with or subsequent to receipt of the event command, the same processing as when it is preempted by another control module. If this processing is cancelled, the control module can undergo appropriate state transition in accordance with the state of an hierarchically superior control module.

Moreover, a control module that is connected hierarchically below a control module that has received an event command has an existing state of preemption cancelled when it receives the event command.

Specific examples of a control module that has received an event command performing “the same processing as when it is preempted by another control module” would be recording information relating to the issuing source of that event command, and deleting this recorded information when the event command is cancelled. Such processing facilitates recognition of the validity or invalidity of the processing by the event command issuing source.

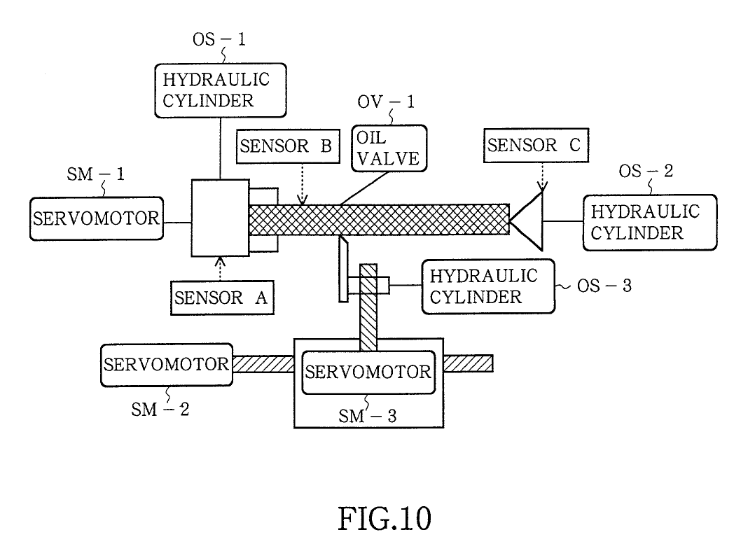

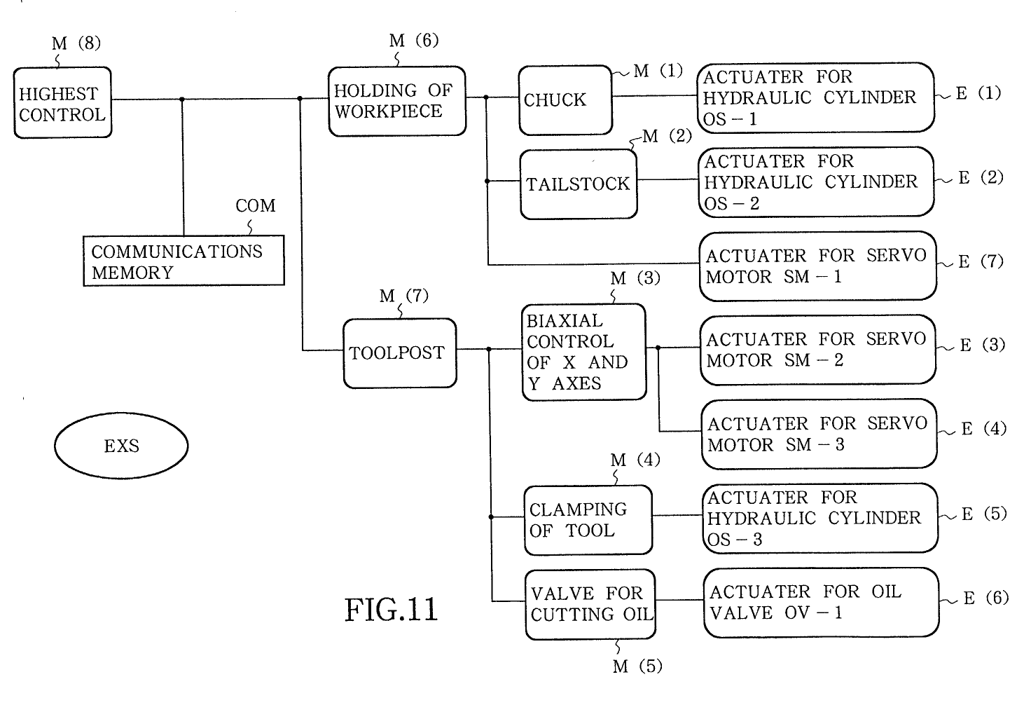

Next, a specific operation of a control system according to this embodiment of the invention will be described with reference to FIG. 10 and FIG. 11. FIG. 10 shows the configuration of the main parts of a lathe, while FIG. 11 is a control system diagram of the lathe. The lathe depicted in FIG. 10 comprises servomotors SM-1, SM-2 and SM-3, hydraulic cylinders OS-1, OS-2 and OS-3, and oil valve OV-1. Servomotor SM-1 is for rotating the main shaft and causes the workpiece to rotate. This servomotor SM-1 rotates one way only and does not reverse. Because servomotor SM-1 is for rotating the workpiece, complicated control is not required and rotation is started as soon as the workpiece has been fixed in position. Servomotor SM-2 is for supplying X-axis feed to the toolpost, and can rotate in both directions. Servomotor SM-3 is for supplying Y-axis feed to the toolpost and can also rotate in both directions. Hydraulic cylinder OS-1 serves to drive the chuck that holds the workpiece. Hydraulic cylinder OS-2 serves to drive the tailstock. Hydraulic cylinder OS-3 is used to grip the tool. Oil valve OV-1 is used to supply cutting oil to the workpiece. Sensor A is used to confirm that the chuck is at a prescribed position or has returned to its origin. Sensor B is used to confirm whether a workpiece is present. Sensor C is used to confirm that the tailstock is at a prescribed position or has returned to its origin.

FIG. 11 is a control system diagram of the lathe depicted in FIG. 10. Hydraulic cylinder OS-1 is assigned as controlled element E(1), hydraulic cylinder OS-2 as controlled element E(2), servomotor SM-2 as controlled element E(3), servomotor SM-3 as controlled element E(4), hydraulic cylinder OS-3 as controlled element E(5), and oil valve OV-1 as controlled element E(6). Control module M(1) controls hydraulic cylinder OS-1, control module M(2) controls hydraulic cylinder OS-2, control module M(3) controls servomotors SM-2 and SM-3, control module M(4) controls hydraulic cylinder OS-3, and control module M(5) controls oil valve OV-1.

Control module M(6) controls control modules M(1) and M(2) and servomotor SM-1, and control module M(7) controls control modules M(3), M(4) and M(5). Control module M(8) controls control modules M(6) and M(7). Communications memory COM is also provided and can be accessed by each control module M(1) to M(8).

Although communication modules M(1) to M(8) shown in FIG. 11 are arranged in their prescribed positions, in their initial state they do not yet display any of their functions (see FIG. 3). According to this invention, the functions of control modules M(1) to M(8) are elicited by job commands.

Three methods for transmitting job commands may be considered. According to the first method, external system EXS successively preempts control modules M(1) to M(8) and transmits job commands to them one by one. According to the second method, external system EXS preempts only control module M(8), which is highest in the hierarchy, and transmits a job command to this control module. Thereafter, control module M(8) successively preempts subordinate control modules M(1) to M(7) and transmits job commands to them one by one. According to the third method, external system EXS preempts only hierarchically highest control module M(8) and transmits a job command to this control module. Thereafter, control module M(8) preempts control module M(6) or M(7) and transmits a job command, and the control module M(6) or M(7) to which the job command was transmitted preempts a same-ranking or subordinate control module and transmits a job command to it, whereupon the control module to which the job command was transmitted preempts a same-ranking or subordinate control module and transmits a job command to it.

Although the user can decide which of these methods to select, preferably the second or third method is selected, since these serve to lighten the processing load incurred by external system EXS in transmitting job commands. The third method should be selected in order to distribute the processing load incurred in transmitting job commands among control modules M(1) to M(8).

The job commands serve to elicit the functions of the control modules, with control module M(8) performing overall control, control module M(7) controlling the toolpost, control module M(6) controlling the holding of the workpiece, control module M(5) controlling the valve for the cutting oil, control module M(4) controlling the clamping of the tool, control module M(3) having biaxial control of the X and Y axes, control module M(2) controlling the tailstock, and control module M(1) controlling the chuck.

Next, the operation of job commands, state commands and event commands will be explained using as an example the process whereby the lathe depicted in FIG. 10 chucks and cuts a workpiece. First of all, external system EXS issues a state command to hierarchically highest control module M(8), whereupon control module M(8) undergoes a state transition from start mode to normal operating mode. In the example of FIG. 11, because none of control modules M(1) to M(7) has been preempted by another command issuing source, the state command issued by external system EXS extends to each of these control modules M(1) to M(7) as well, these being connected hierarchically below control module M(8). Each control module M(1) to M(7) then undergoes state transition from start mode to normal operating mode.

At this point in time, if the job command “start” is issued to control module M(8) from external system EXS, control module M(8) receives this “start” job command and issues the job command “fix” to control module M(6). When control module M(6) receives this “fix” job command, it issues the job command “close chuck” to control module M(1), and issues the job command “start tailstock” to control module M(2).

When control module M(1) detects from the output of sensor B that the workpiece has been set in a prescribed position, it drives hydraulic cylinder OS-1 in response to the “close chuck” job command and actually closes the chuck. In response to the “start tailstock” job command, control module M(2) starts the tailstock by driving hydraulic cylinder OS-2 while monitoring the output of sensor C. When these jobs have been completed, control module M(6) is notified.

Control module M(6) then notifies control module M(8) that the jobs pertaining to the “fix” job command have been completed, M(8) being the issuing source of that job command. When control module M(8) recognizes that these jobs have been completed, it issues the job command “cut” to control module M(7). When control module M(7) receives this “cut” job command, it issues the job command “move toolpost” to control module M(3); issues the job command “clamp tool” to control module M(4); and issues the job command “lubricate” to control module M(5).

In response to the “move toolpost” job command, control module M(3) causes the toolpost to move to a prescribed position by using servomotors SM-2 and SM-3 to numerically control the X and Y axes. In response to the “clamp tool” job command, control module M(4) clamps a prescribed tool by driving hydraulic cylinder OS-3. In response to the “lubricate” job command, control module M(5) performs lubrication by driving oil valve OV-1. The workpiece is cut in a prescribed shape by means of these jobs. Control module M(7) is notified when these jobs have been completed. Control module M(7) then notifies control module M(8) that the jobs pertaining to the “cut” job command have been completed, M(8) being the issuing source of that job command. As a result, control module M(8) recognizes that the jobs have been completed.

If the job command “start” is again issued to control module M(8) from external system EXS, the foregoing procedures are executed again. However, because control modules M(1) to M(7) have already undergone state transition from start mode to normal operating mode, on this second and subsequent occasions external system EXS does not issue a state command to control module M(8).

During these operations, if a situation occurs that makes it desirable for control modules M(1) to M(8) to urgently undergo state transition to a mode such as alarm mode, stop mode, hold mode, manual control mode, reverse mode or exceptional operating mode, external system EXS issues an event command to control module M(8). The event command spreads from control module M(8) to control modules M(1) to M(7), with the result that control modules M(1) to M(8) all rapidly undergo state transition to whichever of the above modes is the object of the event command.

When processing sufficient to achieve the daily production target has been completed and operations for that day are to be ended, external system EXS issues a state command to control module M(8), which then undergoes state transition from normal operating mode to stop mode. This state command spreads to control modules M(1) to M(7) as well, so that each of these control modules also undergoes state transition from normal operating mode to stop mode, and operations for that day are terminated.

As has been described above, this invention can respond easily to a plurality of different situations, and can simplify control, by using a plurality of command types with different characteristics.

What is claimed is:

1. A control system comprising a plurality of control modules for individually controlling a plurality of controlled elements, this plurality of control modules being configured in a tree-like hierarchical structure, and all the control modules being provided with a common set of modes and mode transitions, wherein the commands that can be given to each control module comprise:
a first command that is validly received on the basis of preemption processing whereby the command issuing source acquires in advance the right to issue the command to a control module that constitutes the destination of that command, and that is valid at that control module only;
a second command that is validly received on the basis of the aforementioned preemption processing, but that is also valid at a subordinate control module provided that this has not been preempted by a command issuing source other than the command issuing source of the second command; and
a third command that does not require the aforementioned preemption processing in order to be received, and that is also valid at a control module that is subordinate to the control module in question.

2. A control system claimed in claim 1, wherein the first command is a “job command” for ordering a “job” that executes a function of the control module in question; the second command is a “state command” for ordering a state transition of the control module in question; and the third command is an “event command” for causing a mode transition of the control module in question and of all its subordinate control modules.

3. A control system claimed in claim 2, wherein when a control module has received a second command and a subordinate control module has been preempted by a command issuing source other than the command issuing source of said second command, the state transition of that preempted control module is inhibited until its preemption processing is cancelled.

4. A control system claimed in claim 1, wherein the modes and mode transitions comprise:
a start mode for controlling the starting of the corresponding controlled elements;
a normal operating mode to which direct transition can be made from the start mode, and which controls the normal operation of said controlled elements;
a stop mode to and from which mutual direct transitions can be made from and to the normal operating mode, said stop mode controlling the stopping of said controlled elements;
a hold mode to and from which mutual direct transitions can be made from and to the stop mode, and from which direct transition can be made to the start mode, said hold mode controlling the aforementioned controlled elements in a hold state;
a reverse mode to which direct transition can be made from the hold mode, and to and from which mutual direct transitions can be made from and to the stop mode, said reverse mode controlling the reversing of the aforementioned controlled elements;
a manual control mode to which direct transition can be made from the hold mode, and to and from which mutual direct transitions can be made from and to the stop mode, and from which transitions can be made to the normal operating mode or the start mode, said manual control mode being used for manual control of the aforementioned controlled elements;
an alarm mode to which transition can be made from any of the aforementioned modes and which generates an alarm;
an exceptional operating mode to which transition can be made from any of the aforementioned modes and which temporarily causes at least some of these modes to operate out-of-step; and
an end mode to which direct transition can be made from the hold mode, and which terminates the control of the controlled elements.

5. A control system claimed in claim 4, wherein the start mode comprises a cold start mode which creates a control file, and a hot start mode to which a transition is made from this cold start mode, and which writes the file data to RAM.

6. A control system claimed in claim 4, wherein the normal operating mode comprises an origin mode for confirming that the controlled elements are at their origins; a restoration mode for restoring a sequence of automatically operating controlled elements to the state just before the sequence was interrupted; a preparation mode which prepares for automatic operation of the controlled elements; and a running mode for automatically operating the controlled elements.

7. A control system claimed in claim 4, wherein the stop mode comprises an urgent stop mode for urgently stopping the operation of the controlled elements; a decelerating stop mode for gradually stopping the operation of the controlled elements; and a stepped stop mode for stopping the operation of the controlled elements at breaks in its sequence.

8. A control system claimed in claim 4, wherein the hold mode comprises a CPU stop mode capable of stopping the CPU; a control release mode for releasing the controlled elements from control; a control restore mode for bringing the released controlled elements back under control; and a diagnostic mode capable of converting the operating state of the controlled elements into data and of modifying the control specification.

9. A control system claimed in claim 4, wherein the alarm mode comprises an abnormality stop mode for stopping the operation of a controlled element when an abnormality has been detected in its operation; and an emergency stop mode for making an emergency stop in accordance with external instructions, irrespective of the operating status.

10. A control method for a control system comprising a plurality of control modules for individually controlling a plurality of controlled elements, the plurality of control modules being configured in an hierarchical structure, and all control modules being provided with a common set of modes and mode transitions, wherein:
the job command for causing a function of a control module to be implemented is issued after the job command issuing source has performed preemption processing for acquiring in advance the right to issue the job command to a control module that constitutes the destination of that job command;
the state command for causing a transition of the state of a control module is issued by the state command issuing source after it has performed preemption processing for acquiring in advance the right to issue a state command to a control module that constitutes the destination of that state command; said state command causing a transition of the state of that control module and of a subordinate control module provided that this has not been preempted by a state command issuing source other than the state command issuing source in question; and
when it is necessary to make the hierarchy of control modules undergo a transition all together as a matter of urgency, an event command that is valid at all the control modules is issued without performing the aforementioned preemption processing.
